(19) United States
(12) Patent Application Publication
(10) Pub. No.: US 2026/0328961 A1
(43) Pub. Date: Oct. 22, 2026

(54) THREE-DIMENSIONAL TRANSIENT ELECTROMAGNETIC MEASUREMENT SYSTEM

(71) Applicants: Jilin University, Changchun (CN); Chongqing Dingfeng Geological Exploration Instrument Co., Ltd., Changchun (CN)

(72) Inventors: Xiujie LUO, Changchun (CN); Zhaofa ZENG, Changchun (CN); Dian WANG, Changchun (CN); Zengshou WANG, Changchun (CN); Biao PENG, Changchun (CN); Jiahe YAN, Changchun (CN); Jun XU, Changchun (CN)

(73) Assignees: Jilin University, Changchun (CN); Chongqing Dingfeng Geological Exploration Instrument Co., Ltd., Changchun (CN)

(21) Appl. No.: 19/643,842

(22) Filed: Apr. 10, 2026

(30) Foreign Application Priority Data
Apr. 21, 2025 (CN) 202510496102.5

(51) Int. Cl. G01V 3/10; G01V 3/15

(52) U.S. Cl. CPC G01V 3/104; G01V 3/15

(57) ABSTRACT

A three-dimensional transient electromagnetic (TEM) measurement system includes: a transmitting subsystem, a receiving subsystem, and a data processing subsystem, all of which are integrated on a vehicle platform, wherein the transmitting subsystem is used for transmitting TEM signals generated by a transmitting coil to each receiving coil; the receiving subsystem is used for receiving electromagnetic signals generated by each receiving coil; the data processing subsystem is used for processing the received electromagnetic signals to obtain a subsurface three-dimensional electrical properties structure. The system employs a TEM method having a high penetration capability in near-surface detection to achieve three-dimensional detection and three-dimensional imaging of a near-surface target, solve the problem of a difficulty in interpreting a two-dimensional TEM resistivity image, improve imaging and interpretation accuracy for a subsurface three-dimensional target, and achieve high-precision detection of a near surface.

### CROSS REFERENCE TO THE RELATED APPLICATIONS

This application is based upon and claims priority to Chinese Patent Application No. 202510496102.5, filed on Apr. 21, 2025, the entire contents of which are incorporated herein by reference.

### TECHNICAL FIELD

The present invention pertains to the technical field of geophysical exploration, and particularly, to a three-dimensional TEM measurement system.

### BACKGROUND

In a TEM, a subsurface electrical properties structure is detected by transmitting a TEM field and receiving an induction signal. Conventional methods are mostly ground-based fixed measurement, with low efficiency and insufficient spatial resolution. Although a two-dimensional vehicle based TEM system has improved efficiency, it still has limitations in three-dimensional data acquisition and processing. In efficient near-surface detection, ground penetrating radar and TEM are the most important methods. A three-dimensional ground penetrating radar technology has very extensive applications in near-surface detection due to its characteristics of high resolution and high-efficiency data acquisition. However, a detection depth of the ground penetrating radar is low, making it difficult to detect a target at a greater depth. The TEM employs an electromagnetic wave with a relatively low frequency to detect subsurface media in the time domain, with a relatively large penetration depth. A basic principle of TEM detection is to apply a pulsed current in a transmitting coil to generate a TEM field, which in turn generates a secondary induced eddy current field in the subsurface media. During an interval of a primary pulse, variation of an induced voltage or an induced magnetic field is recorded through a receiving coil, and an attenuation characteristic of the secondary induced eddy current field is measured, to obtain subsurface geological information and perform imaging of the subsurface media. To recover an impulse response, a high-power multi-channel TEM system simultaneously records a transmitted waveform and a ground response, and ultimately interprets high-power multi-channel TEM data based on the extracted ground impulse response. With the support of national major scientific research and equipment development projects, the research of the high-power multi-channel TEM system has been completed, and the system is undergoing systematic field testing. A transmitter system is composed of a generator, an uncontrolled rectifier bridge, a pulse width modulation direct current (DC)/DC full-bridge converter, an H inverter bridge, and a pattern generator capable of generating a PRBS signal. A dynamic range of an acquisition station is 160 dB, a minimum detectable voltage is 50 nV, a synchronization accuracy is 5 μs, a sampling rate is 16 Ksps, and data transmission is based on the TCP/IP protocol. The high-power multi-channel TEM system transmits a PRBS signal to the ground through a grounding wire, and simultaneously records an electromagnetic field response and a current transmitted on the land. An earth impulse response can be obtained through deconvolution, and ultimately a subsurface resistivity distribution is reconstructed and a desired geological target is located by calculating a subsurface apparent resistivity value.

However, in urban applications, a coil of a conventional TEM system is large and is subject to many interference factors; and an urban ground detection space is limited, making it difficult to carry out measurement work. The conventional technology has further proposed a towed TEM technology for TEM data acquisition and imaging of an urban road. However, it is a single-transmitter single-receiver system, which suffers from serious non-uniqueness in data imaging interpretation, making it difficult to identify subsurface disaster hazards.

### SUMMARY

To solve the above technical problems, the present invention proposes a three-dimensional TEM measurement system, which addresses the problems of low detection depth of three-dimensional ground penetrating radar, and a difficulty in target identification of conventional two-dimensional TEM detection, as well as low efficiency in forming three-dimensional detection. By adopting a TEM method having a high penetration capability in near-surface detection, three-dimensional detection and three-dimensional imaging of a near-surface target are achieved, to solve the problem of a difficulty in interpretation of a two-dimensional TEM resistivity image, improve imaging and interpretation accuracy for a subsurface three-dimensional target, and achieve high-precision detection of a near surface.

To achieve the above objectives, the present invention provides a three-dimensional TEM measurement system, including:
a transmitting subsystem, a receiving subsystem, and a data processing subsystem, all of which are integrated on a vehicle platform;
   the transmitting subsystem is used for transmitting TEM signals generated by a transmitting coil to each receiving coil;
   the receiving subsystem is used for receiving electromagnetic signals generated by each receiving coil;
   the data processing subsystem is used for processing the received electromagnetic signals to obtain a subsurface three-dimensional electrical properties structure.

Optionally, the transmitting subsystem includes a power supply module, a global positioning system (GPS) receiving module, a wireless transceiver module, a display module, a status monitoring module, and a control module;

the power supply module is used for supplying power to the power supply module itself and to the transmitting coil and the receiving coils;

the GPS receiving module is used for receiving and processing synchronization signals from a satellite to obtain latitude and longitude information and a PPS pulse-per-second signal of a target area;

the wireless transceiver module is used for direct wireless communication between the control module and a host;

the display module is used for being connected to the control module and displaying a status of the host;

the status monitoring module is used for detecting a status of an entire system;

the control module is used for sampling a current of the transmitting coil through a current sensor to obtain a voltage signal proportional to the current, where the voltage signal enters a high-speed analog-to-digital converter (ADC) after undergoing corresponding filtering processing and passing through an amplification circuit, and a current sample is obtained after field-programmable gate array (FPGA) processing.

Optionally, the power supply module includes a low-voltage unit and a high-voltage unit;

the low-voltage unit is used for a power supply energy loop of an instrument itself, with energy sourced from an internal 12 V lithium battery or an external 12 V lithium battery, where the energy passes through a selector and then enters a DC/DC conversion circuit in a power supply controller to obtain different types of operating voltages required by the instrument;

the high-voltage unit is used for an energy loop for supplying power to a coil, with energy sourced from an external transmitting coil power supply input port, where the energy passes through an overcurrent protection circuit and an overvoltage protection circuit and then enters an H bridge, an H bridge driving module provides an appropriate insulated gate bipolar transistor (IGBT) driving waveform to drive the H bridge, and the energy is transmitted out through the transmitting coil.

Optionally, the GPS receiving module includes: a GPS antenna, a low-noise amplifier (LNA) amplifier, and a controller, where after the GPS antenna receives the synchronization signals from the satellite, the synchronization signals are preprocessed by the LNA amplifier to obtain the required latitude and longitude information and PPS pulse-per-second signal.

Optionally, the wireless transceiver module includes: an antenna and an LNA amplifier, wherein the antenna is bidirectionally connected to the LNA amplifier, the LNA amplifier is bidirectionally connected to the wireless transceiver module, and the wireless transceiver module is bidirectionally connected to the control module.

Optionally, the receiving subsystem includes a signal processing module, a GPS positioning module, and a control and measurement module;

the signal processing module is used for processing the electromagnetic signals generated by the receiving coils to obtain processed electromagnetic signals;

the GPS positioning module is used for performing secondary measurement positioning based on required latitude and longitude information and PPS pulse-per-second signals that are obtained;

the control and measurement module is used for controlling terminal device and parameter settings, and performing testing and system measurement after determining that GPS signals are valid.

Optionally, the signal processing module includes a signal preprocessing unit, a signal amplification and filtering unit, and an ADC unit;

the signal preprocessing unit is used for preprocessing the electromagnetic signals generated by the receiving coils to obtain preprocessed electromagnetic signals;

the signal amplification and filtering unit is used for performing amplification and filtering processing on the preprocessed electromagnetic signals to obtain filtered electromagnetic signals;

the ADC unit is used for performing digital processing on the filtered electromagnetic signals to obtain digital signals.

Optionally, the data processing subsystem includes a curve normalization unit, a three-dimensional data measurement unit, and a data imaging unit;

the curve normalization unit is used for obtaining attenuation curves of channels 1 to 12 from acquired data, normalizing the attenuation curves based on distribution of a primary field, and obtaining profile maps of the attenuation curves of the channels 1 to 12;

the three-dimensional data measurement unit is used for running a vehicle system, performing continuous measurement for sampling, and measuring a point spacing along a vehicle traveling direction, to obtain three-dimensional measurement data;

the data imaging unit is used for performing imaging on an attenuation curve morphology and resistivity of data to determine a three-dimensional image of a subsurface target.

Technical Effects of the Present Invention:
(1) In terms of a detection efficiency: A single-transmitting and multi-receiving data measurement mode is adopted, which improves efficiency of field detection data acquisition compared with conventional two-dimensional measurement, saves working time, and reduces detection costs.
(2) In terms of a detection capability: The detection capability for a subsurface target is improved, a basis is provided for three-dimensional imaging of the subsurface target and a three-dimensional structure of a target body is obtained, and more subsurface structural information is obtained.
(3) In terms of a detection effect: While ensuring a detection effect for a two-dimensional structural body, a better detection effect is provided for a three-dimensional geological structural body, particularly, for detection of an equiaxed target and a linear target.
(4) In terms of anti-interference: A plurality of receiving coils is adopted, which alleviates interference to a TEM receiving signal due to a local metallic object present beneath a single coil.

### BRIEF DESCRIPTION OF THE DRAWINGS

The drawings, which constitute a part of the present application, are used to provide a further understanding of the present application, and schematic embodiments and descriptions thereof of the present application are used to explain the present application, and do not constitute an undue limitation on the present application. In the drawings:

FIG. 1 is a schematic diagram of a structure of a transmitting coil and a receiving coil according to an embodiment of the present invention;

FIG. 2 is a schematic diagram of a structure of a vehicle overall system according to an embodiment of the present invention;

FIG. 3 is a schematic diagram of a structure of a three-dimensional TEM measurement system according to an embodiment of the present invention;

FIG. 4 is a schematic diagram of a structure of a transmitting subsystem according to an embodiment of the present invention;

FIG. 5 is a schematic diagram of a structure of a power supply module in a transmitting subsystem according to an embodiment of the present invention;

FIG. 6 is a schematic diagram of a structure of a GPS receiving module in a transmitting subsystem according to an embodiment of the present invention;

FIG. 7 is a schematic diagram of a structure of a wireless transceiver module in a transmitting subsystem according to an embodiment of the present invention;

FIG. 8 is a schematic diagram of a structure of a display module in a transmitting subsystem according to an embodiment of the present invention;

FIG. 9 is a schematic diagram of a structure of a status monitoring module in a transmitting subsystem according to an embodiment of the present invention;

FIG. 10 is a schematic diagram of a structure of a control module in a transmitting subsystem according to an embodiment of the present invention;

FIG. 11 is a schematic diagram of a structure of a receiving subsystem according to an embodiment of the present invention;

FIG. 12 is a schematic diagram of a structure of a signal processing module in a receiving subsystem according to an embodiment of the present invention;

FIG. 13 is a schematic diagram of a structure of a GPS positioning module in a receiving subsystem according to an embodiment of the present invention; and

FIG. 14 is a schematic diagram of a structure of a control and measurement module in a receiving subsystem according to an embodiment of the present invention.

### DETAILED DESCRIPTION OF THE EMBODIMENTS

It should be noted that embodiments in the present application and features in embodiments may be combined with each other without conflict. The present application will be described in detail below with reference to the drawings and in conjunction with embodiments.

It should be noted that the steps shown in the flowcharts of the drawings may be executed in a computer system like a set of computer-executable instructions, and although a logical order is shown in the flowcharts, in some cases, the steps shown or described may be executed in an order different from the order herein.

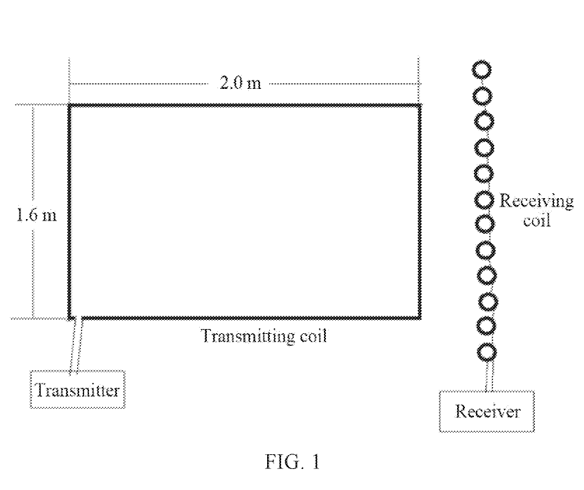

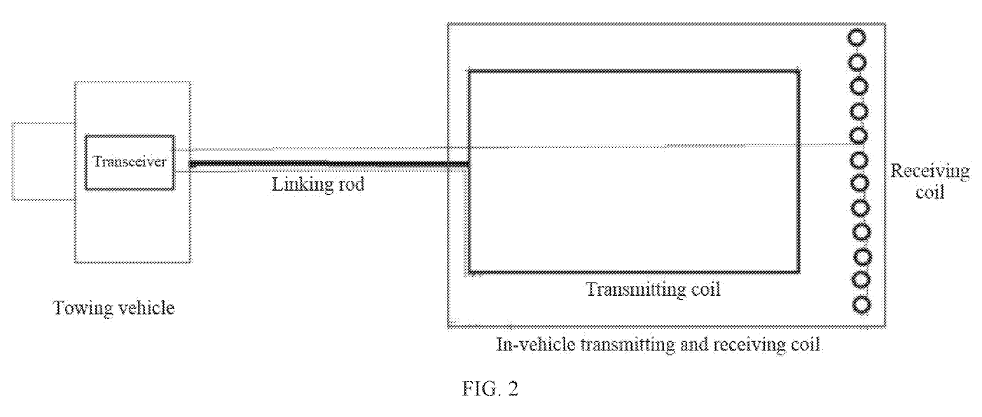

As shown in FIG. 1, the technical solution of a three-dimensional TEM measurement system according to the present embodiment includes four parts: a transmitting coil, a transmitter, a receiving coil, and a receiver. In the system, a plurality of receiving coils are connected to a multi-channel receiver, and the transmitting coil is connected to the transmitter, forming a single-transmit multi-receive system. The transmitting coil has a rectangular structure and is wound with a plurality of turns (2 to 5 turns); the receiving coil has a circular structure and is wound with multiple turns (10 to 30 turns), a plurality of groups are connected in series, and the transmitting coil is placed at a rear end of the transmitting coil, to counteract strong signal influence of the primary field by using a compensation coil, thereby reducing a blind zone of a received signal, and improving an effective length of the signal. Since secondary induced fields at different receiving positions have some differences, the received signals need to be further normalized. FIG. 2 is a schematic diagram of a vehicle control system. The detection system in FIG. 1 is towed forward by a towing vehicle, with a spacing of 3 to 6 meters between the vehicle and the transmitting coil, to reduce interference from the towing vehicle. The transmitting and receiving system is placed inside the towing vehicle, and is configured with a GPS measurement control system.

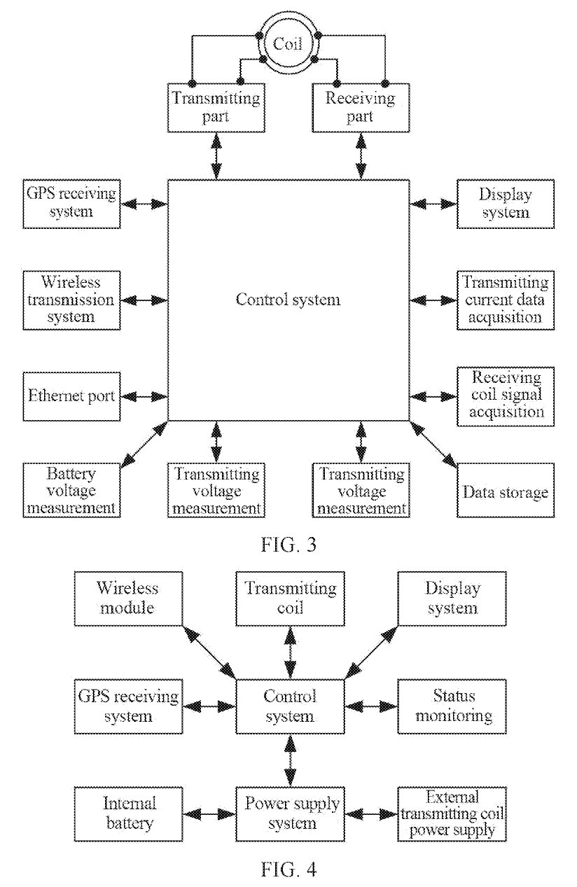

As shown in FIG. 3, a three-dimensional TEM measurement system is provided in this embodiment, including:
a transmitting subsystem, a receiving subsystem, and a data processing subsystem, all of which are integrated on a vehicle platform;
   the transmitting subsystem is used for transmitting TEM signals generated by a transmitting coil to each receiving coil;
   the receiving subsystem is used for receiving electromagnetic signals generated by each receiving coil;
   the data processing subsystem is used for processing the received electromagnetic signals to obtain a subsurface three-dimensional electrical properties structure.

Further, the transmitting subsystem includes a power supply module, a GPS receiving module, a wireless transceiver module, a display module, a status monitoring module, and a control module;

the power supply module is used for supplying power to the power supply module itself and to the transmitting coil and the receiving coils;

the GPS receiving module is used for receiving and processing synchronization signals from a satellite to obtain latitude and longitude information and a PPS pulse-per-second signal of a target area;

the wireless transceiver module is used for direct wireless communication between the control module and a host;

the display module is used for being connected to the control module and displaying a status of the host;

the status monitoring module is used for detecting a status of an entire system;

the control module is used for sampling a current of the transmitting coil through a current sensor to obtain a voltage signal proportional to the current, where the voltage signal enters a high-speed ADC after undergoing corresponding filtering processing and passing through an amplification circuit, and a current sample is obtained after FPGA processing.

Further, the power supply module includes a low-voltage unit and a high-voltage unit;

the low-voltage unit is used for a power supply energy loop of an instrument itself, with energy sourced from an internal 12 V lithium battery or an external 12 V lithium battery, where the energy passes through a selector and then enters a DC/DC conversion circuit in a power supply controller to obtain different types of operating voltages required by the instrument;

the high-voltage unit is used for an energy loop for supplying power to a coil, with energy sourced from an external transmitting coil power supply input port, where the energy passes through an overcurrent protection circuit and an overvoltage protection circuit and then enters an H bridge, an H bridge driving module provides an appropriate IGBT driving waveform to drive the H bridge, and the energy is transmitted out through the transmitting coil.

Further, the GPS receiving module includes: a GPS antenna, an LNA amplifier, and a controller, where after the GPS antenna receives the synchronization signals from the satellite, the synchronization signals are preprocessed by the LNA amplifier to obtain the required latitude and longitude information and PPS pulse-per-second signal.

Further, the wireless transceiver module includes: an antenna and an LNA amplifier, wherein the antenna is bidirectionally connected to the LNA amplifier, the LNA amplifier is bidirectionally connected to the wireless transceiver module, and the wireless transceiver module is bidirectionally connected to the control module.

Specifically, as shown in FIG. 4, a wire terminal device is connected to the TEM system through a wireless module, and under control of the control system, driven by a precise time signal from the GPS receiving system, power supply of an external transmitting coil is converted by the power system into a required waveform and loaded onto the transmitting coil, and a varying current is emitted through the coil in a form of an electromagnetic field. Status monitoring is performed to monitor an operating state of each circuit in real time and protect the circuit in real time.

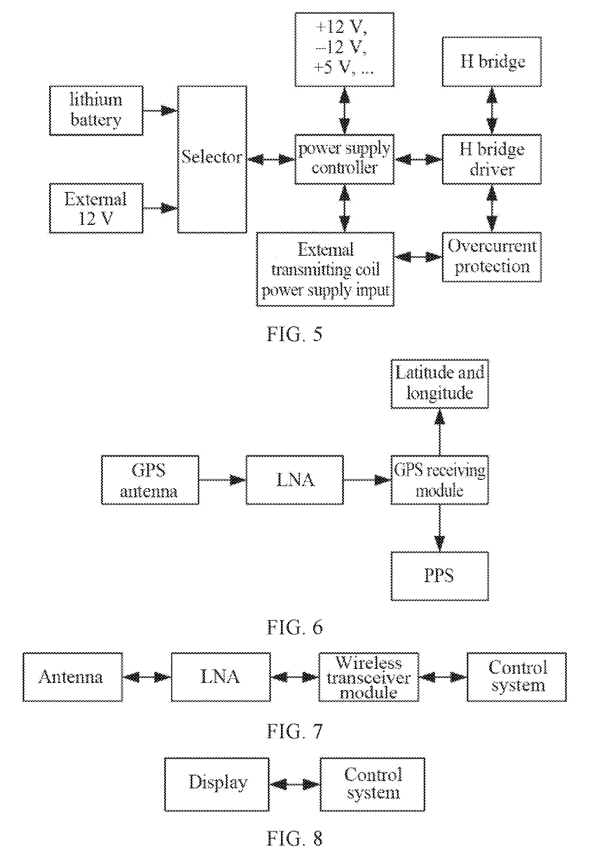

As shown in FIG. 5, the power supply module is divided into two parts: a low-voltage part and a high-voltage part. The low-voltage part is an energy loop for supplying power to the instrument itself, with energy sourced from an internal 12 V lithium battery or an external 12 V lithium battery, where the energy passes through a selector and then enters a DC/DC conversion circuit in the power supply controller, to obtain different operating voltages required by the instrument; and the high-voltage part is an energy loop for supplying power to a coil, with energy sourced from an external transmitting coil power supply input port, where the energy passes through a protection circuit like an overcurrent and an overvoltage protection circuit and then enters an H bridge, an H bridge driving module provides a suitable IGBT driving waveform to drive the H bridge, and finally the energy is transmitted through the transmitting coil. The transmitting coil provides a transmitting energy discharge path of the TEM instrument, and a reasonable external transmitting coil supply voltage is selected based on an internal resistance thereof. Theoretically, a current not higher than 80% of a maximum transmitting current of the instrument is used as a selection basis.

The GPS receiving module includes an antenna, an LNA, a controller, and the like, as shown in FIG. 6. After the GPS antenna receives the synchronization signal from the satellite, the synchronization signal enters the GPS receiving module after being preprocessed by the LNA amplifier to obtain the required latitude and longitude information and the PPS pulse-per-second signal for use of the control system.

As shown in FIG. 7, the wireless transceiver module implements a wireless connection between the wireless terminal and the host, so that all operations can be performed through the wireless terminal, thereby avoiding inconvenience of operating through the host. Data obtained upon completion of measurement is displayed in real time through the wireless terminal, and a graph can be generated with one click.

As shown in FIG. 8, the display module implements display of a main state of the host, like a battery voltage, a transmitting voltage, a transmitting current, GPS status information, and alarm information.

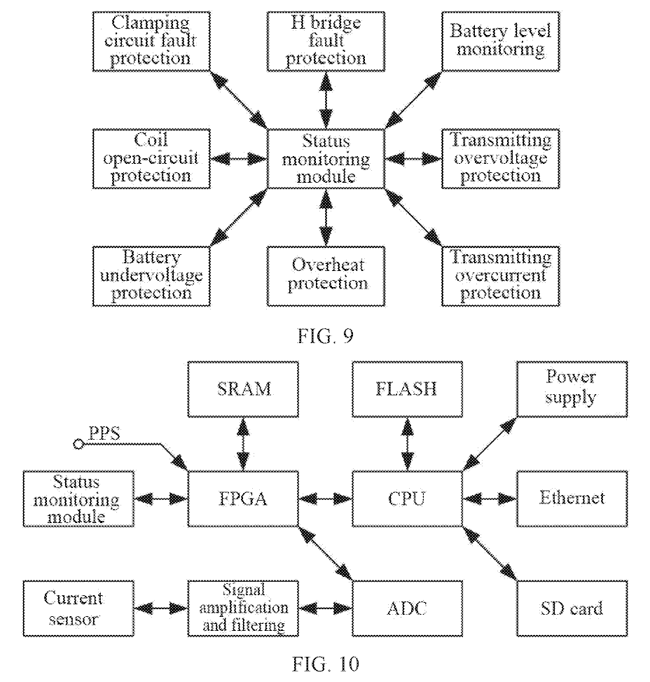

As shown in FIG. 9, the status monitoring module implements real-time monitoring of key parts of the entire instrument, including but not limited to the functions shown in the above figures. The system is intended to improve overall completeness of the system and make the product easy to maintain. A turn-off time detection circuit and a constant voltage clamping circuit are integrated into the module to implement functions of the transmitter and measurement of a basic parameter.

As shown in FIG. 10, a real-time processing system is constituted by an FPGA and a CPU. A current of the transmitting coil is sampled by a current sensor to obtain a voltage signal proportional to the current. The voltage signal enters a high-speed ADC after undergoing corresponding filtering processing and passing through an amplification circuit, and receives processing by the FPGA, to obtain a complete current sample. The system has an extended Ethernet port to facilitate extended applications, and has a reserved SD card to facilitate dual backup of data, thereby ensuring data integrity.

Further, the receiving subsystem includes a signal processing module, a GPS positioning module, and a control and measurement module;

the signal processing module is used for processing the electromagnetic signals generated by the receiving coils to obtain processed electromagnetic signals;

the GPS positioning module is used for performing secondary measurement positioning based on required latitude and longitude information and PPS pulse-per-second signals that are obtained;

the control and measurement module is used for controlling terminal device and parameter settings, and performing testing and system measurement after determining that GPS signals are valid.

Specifically, as shown in FIG. 11, driven by the PPS pulse-per-second, the transmitting system and the receiving system achieve synchronization in a strict sense. After the receiving coil receives an eddy current field signal from an object under detection, the signal enters the digital processing unit within the control system for signal processing after corresponding amplification and filtering, and subsequent corresponding digital processing and storage are completed.

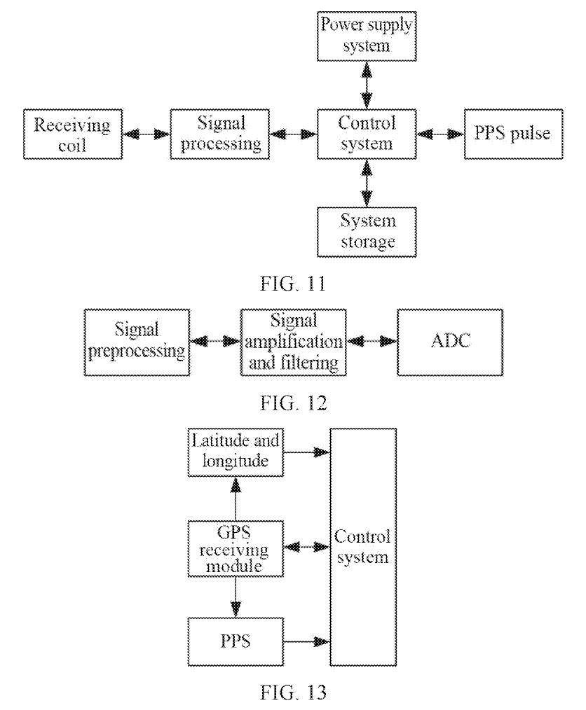

Further, as shown in FIG. 12, the signal processing module includes a signal preprocessing unit, a signal amplification and filtering unit, and an ADC unit;

the signal preprocessing unit is used for preprocessing the electromagnetic signals generated by the receiving coils to obtain preprocessed electromagnetic signals;

the signal amplification and filtering unit is used for performing amplification and filtering processing on the preprocessed electromagnetic signals to obtain filtered electromagnetic signals;

the ADC unit is used for performing digital processing on the filtered electromagnetic signals to obtain digital signals.

As shown in FIG. 13, the GPS positioning system provides information such as a PPS pulse-per-second and latitude and longitude that is required by the control system, to achieve time synchronization of the measurement and a location information recording function, for facilitating accurate positioning for secondary measurement of an anomalous point.

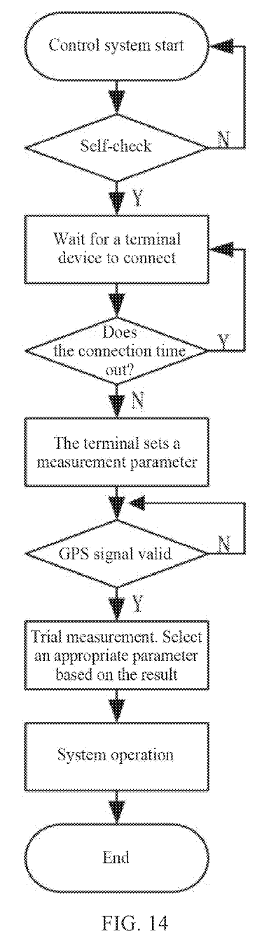

As shown in FIG. 14, the control and measurement module: after the control system is initialized, starts and performs a self-check, and when the self-check does not pass or is not completed, returns to a start process to perform the self-check again; when the system self-check is completed, performs a terminal device connection, where if the connection times out, it indicates that the device is not properly connected, and it is necessary to wait for the terminal device again; and after the terminal device is successfully connected, performs measurement parameter settings, and determines whether the GPS signal is valid, where when the GPS signal detection passes, the terminal device performs a self-test and selects an appropriate parameter based on a test result, and finally starts to perform system measurement.

Further, the data processing subsystem includes a curve normalization unit, a three-dimensional data measurement unit, and a data imaging unit;

the curve normalization unit is used for obtaining attenuation curves of channels 1 to 12 from acquired data, normalizing the attenuation curves based on distribution of a primary field, and obtaining profile maps of the attenuation curves of the channels 1 to 12;

the three-dimensional data measurement unit is used for running a vehicle system, performing continuous measurement for sampling, and measuring a point spacing along a vehicle traveling direction, to obtain three-dimensional measurement data;

the data imaging unit is used for performing imaging on an attenuation curve morphology and resistivity of data to determine a three-dimensional image of a subsurface target.

Specifically, the acquired data are used to obtain the attenuation curves of the channels 1 to 12, the attenuation curves are normalized based on the distribution of the primary field, and the attenuation curve profile maps of the channels 1 to 12 are obtained. An operating speed of the vehicle system is 3 to 10 km/h, in continuous measurement, one sampling is completed in 1 s, a measurement point spacing in a vehicle traveling direction is 0.8 to 2.7 meters, and in traveling continuous measurement, three-dimensional data of 12 × n is formed. Imaging is performed on attenuation curve morphology and resistivity of the data to determine a three-dimensional image of a subsurface target.

The present invention adopts a detection technology of small coil transmission and small coil reception, forming a three-dimensional single-transmitting and multi-receiving system of single coil transmission and multiple coil reception. By improving a conventional two-dimensional detection method of single-transmitting and single-receiving, and developing a detection technology of single-transmitting and multi-receiving, the problem that a conventional detection system can only achieve two-dimensional detection, and cannot identify a three-dimensional subsurface target is solved. The single-transmitting and multi-receiving TEM measurement can further form a two-dimensional cross section and advance detection in a measurement direction, completing subsurface three-dimensional measurement. Particularly for a linear subsurface target, which appears as point-like in conventional two-dimensional detection while appears as a linear feature in three-dimensional detection, a subsurface target body is more easily identified on a three-dimensional inversion image. Therefore, the present invention can more clearly identify a subsurface pipeline and a geological hazard risk. In addition, since data acquisition time of the present invention is short, a measurement speed of 3 to 10 km/h can still be achieved on the basis of 10 to 64 stacking times, providing a possibility for rapid and large-scale detection in fields such as subsurface pipeline measurement, geological hazard risk detection, and soil detection.

The present invention is achieved by the following technical solutions: First, a framework of a small coil three-dimensional TEM measurement system is constructed. In TEM detection in an urban environment and regional detection, a vehicle method is adopted for detection. The TEM system is located at a rear of a vehicle, including a multi-turn rectangular transmitting coil of 1.6 meters × 2 meters, 16 receiving coils are located on an outer side of a short edge at a rear of the transmitting coil, the receiving coils are multi-turn coils with a diameter of 5 centimeters, with a spacing of 5 centimeters, and a distance from one side of the transmitting coil of 0.5 to 0.8 meters. The transmitting coil and the receiving coil are located in a same plane, with a height above the ground of 10 to 20 centimeters, and the transmitting coil and the receiving coil are both supported by one non-metallic frame. Secondly, the measurement control system includes a GPS receiving system, which controls system transmission and measurement, as well as the positioning of measurement. Thirdly, the transmitting system employs rectangular square wave transmission, with a current between 10 and 30 A. The measurement system starts measurement after transmission is turned off, and measurement duration is 10 ms. Fourthly, based on multi-channel reception, normalization is performed by utilizing a characteristic of a primary field, and then resistivity inversion or imaging is performed to form a three-dimensional subsurface resistivity distribution map in a measurement direction.

The above are only preferred specific embodiments of the present application, but the protection scope of the present application is not limited thereto. Any changes or substitutions that can be easily conceived by those skilled in the art within the technical scope disclosed in the present application should be covered within the protection scope of the present application. Therefore, the protection scope of the present application should be defined by the protection scope of the claims.

What is claimed is:

1. A three-dimensional transient electromagnetic (TEM) measurement system, comprising:
a transmitting subsystem, a receiving subsystem, and a data processing subsystem, wherein all of the transmitting subsystem, the receiving subsystem, and the data processing subsystem are integrated on a vehicle platform, wherein
the transmitting subsystem is allowed for transmitting TEM signals generated by a transmitting coil to each receiving coil;
the receiving subsystem is allowed for receiving electromagnetic signals generated by each receiving coil;
the receiving subsystem comprises a signal processing module, a global positioning system (GPS) positioning module, and a control and measurement module;
the signal processing module is allowed for processing the electromagnetic signals generated by receiving coils to obtain processed electromagnetic signals;
the GPS positioning module is allowed for performing secondary measurement positioning based on required latitude and longitude information and PPS pulse-per-second signals, wherein the required latitude and longitude information and the PPS pulse-per-second signals are obtained; and
the control and measurement module is allowed for controlling terminal device and parameter settings, and performing testing and system measurement after determining that GPS signals are valid;
the signal processing module comprises a signal preprocessing unit, a signal amplification and filtering unit, and an analog-to-digital converter (ADC) unit;
the signal preprocessing unit is allowed for preprocessing the electromagnetic signals generated by the receiving coils to obtain preprocessed electromagnetic signals;
the signal amplification and filtering unit is allowed for performing amplification and filtering processing on the preprocessed electromagnetic signals to obtain filtered electromagnetic signals; and
the ADC unit is allowed for performing digital processing on the filtered electromagnetic signals to obtain digital signals;
the transmitting subsystem comprises a power supply module, a GPS receiving module, a wireless transceiver module, a display module, a status monitoring module, and a control module;
the power supply module is allowed for supplying power to the power supply module itself and to the transmitting coil and the receiving coils;
the GPS receiving module is allowed for receiving and processing synchronization signals from a satellite to obtain latitude and longitude information and a PPS pulse-per-second signal of a target area;
the wireless transceiver module is allowed for direct wireless communication between the control module and a host;
the display module is allowed for being connected to the control module and displaying a status of the host;
the status monitoring module is allowed for detecting a status of an entire system; and
the control module is allowed for sampling a current of the transmitting coil through a current sensor to obtain a voltage signal proportional to the current, wherein the voltage signal enters a high-speed ADC after undergoing corresponding filtering processing and passing through an amplification circuit, and a current sample is obtained after field-programmable gate array (FPGA) processing;
the GPS receiving module comprises: a GPS antenna, a first low-noise amplifier (LNA) amplifier, and a controller, wherein after the GPS antenna receives the synchronization signals from the satellite, and the synchronization signals are preprocessed by the first LNA amplifier to obtain the required latitude and longitude information and the PPS pulse-per-second signals; and
the wireless transceiver module comprises: an antenna and a second LNA amplifier, wherein the antenna is bidirectionally connected to the second LNA amplifier, the second LNA amplifier is bidirectionally connected to the wireless transceiver module, and the wireless transceiver module is bidirectionally connected to the control module,
wherein detection is performed in a vehicle manner, a TEM system is located behind a vehicle and comprises a multi-turn rectangular transmitting coil, 16 receiving coils are provided on an outer side of a short edge at a rear part of the transmitting coil, and the transmitting coil and the receiving coils are located in an identical plane; and a transmitting system performs rectangular square wave transmission, the three-dimensional TEM measurement system starts measurement after the rectangular square wave transmission is turned off, normalization is performed based on multi-channel reception by utilizing a characteristic of the primary field, and then resistivity inversion or imaging is performed to form a three-dimensional subsurface resistivity distribution map along a measurement direction.
